(19) United States
(12) Patent Application Publication
(10) Pub. No.: US 2013/0174734 A1
(43) Pub. Date: Jul. 11, 2013

(54) METHOD TO DECREASE THE AMOUNT OF PARTICULATE MATERIAL SUSPENDED IN AIR OR WATER, COMPRISING THE AGGLOMERATION OF THE SUSPENDED PARTICULATE MATERIAL WITH NEGATIVELY CHARGED EXOPOLYSACCHARIDES

(71) Applicant: Cultivos Hidrobiologicos y Biotecnologia Aguamarina S.A., Antofagasta (CL)

(72) Inventors: Pamela Chavez Crooker, Antofagasta (CL); Jeannette Marisol Vera Araya, Antofagasta (CL); Jorge Enrique Castro Ponce, Antofagasta (CL); Johanna del Rosario Obreque Contreras, Antofagasta (CL)

(73) Assignee: Cultivos Hidrobiologicos y Biotecnologia Aguamarina S.A., Antofagasta (CL)

(21) Appl. No.: 13/734,430

(22) Filed: Jan. 4, 2013

(30) Foreign Application Priority Data
Jan. 6, 2012 (CL) 0047-2012

(51) Int. Cl. B01D 47/00; C02F 1/52

(52) U.S. Cl. CPC B01D 47/00; C02F 1/5263
USPC 95/152; 210/730

(57) ABSTRACT

The invention is directed to decreasing the amount of particulate material suspended in air or water, in any situation in which it is desired to decrease the amount of particulate material in suspension, and especially in industrial processes that generate particulate material suspended in air or water. In particular, the invention is directed to decreasing the particulate material in suspension by means of agglomeration with negatively charged ExoPolySaccharides (EPS). To decrease the amount of particulate material suspended in air, this can be sprayed with a negatively charged EPS solution according to the invention, or the EPS can be immobilized on a filter which the air with particulate material passes through. To decrease the amount of particulate material in water, a suspension with a negatively charged EPS solution according to the invention is added to said water, which agglomerates and settles the particulate material by means of the charge attraction principle.

### REFERENCE TO RELATED APPLICATION

This application claims the benefit of Chilean Patent Application No. 0047-2012, filed Jan. 6, 2012, which is hereby incorporated by reference.

### TECHNICAL FIELD

The invention is directed to a method to decrease the amount of particulate material suspended in air or water, in any situation in which it is desired to decrease the amount of particulate material in suspension, and especially in industrial processes that generate particulate material suspended in air or water.

In particular, the invention is directed to a method to decrease the particulate material in suspension, either in air or water, by means of agglomeration with negatively charged ExoPolySaccharides (EPS). To decrease the amount of particulate material suspended in air, this can be sprayed with a negatively charged EPS solution according to the invention, or the EPS can be immobilized on a filter which the air with particulate material passes through. To decrease the amount of particulate material in water, a suspension with a negatively charged EPS solution according to the invention is added to said water, which agglomerates and settles the particulate material by means of the charge attraction principle.

### STATE OF THE ART

Exopolysaccharides (EPS) are produced by many varied types of microorganisms. Likewise, their composition also varies. In general terms, exopolysaccharides are biopolymers produced by some microorganisms and secreted into the extracellular space, which are formed by monomeric sugar residues linked to form the main structure. These monomers can or cannot be substituted by groups such as acetate, pyruvate, succinate, sulfate or phosphate, for instance. In this way, depending on their composition, EPS can have a net charge, which can be either negative or positive, and be present in a higher or lower degree.

In a search of the state of the art, we have not found any method to decrease the particulate material in suspension, either in air or water, by means of agglomeration with negatively charged EPS. However, there are close documents, which will be analyzed in the following paragraphs.

U.S. Pat. No. 4,374,814 (Gaylord, N., Feb. 22, 1983) discloses a method to purify air from gaseous formaldehyde, consisting in letting the air come in contact with a solid composition essentially consisting in one or more polyhydric water-soluble compounds and atmospheric humidity. Although claim 2 discloses that said polymers can be polysaccharides, which can be selected from the groups consisting in plant polysaccharides, other polysaccharides and microbial polysaccharides, in the description and the examples it is established that the polymers are especially selected from the groups consisting in starch, cellulose and their ethers, esters and other derivatives (see column 3, lines 20-50 of U.S. Pat. No. 4,374,814). The present invention differs from U.S. Pat. No. 4,374,814 firstly in its technical field, since U.S. Pat. No. 4,374,814 is directed to remove gaseous formaldehyde from air, while the present invention is directed to remove particulate material corresponding to solid material in suspension. Secondly, it differs in the polymers used, since U.S. Pat. No. 4,374,814 uses starch and cellulose and does not mention the use of EPS, while the present invention uses negatively charged EPS. Besides, the present invention can be used without the need of a solid support, since it can be directly sprayed into the air to decrease the amount of particulate material in suspension.

The document WO1995025604A (Polysaccharides Industries AB PSI, Mar. 23, 1995) describes a process to protect surfaces from contamination and facilitate the removal of said contamination from said surface. Said process comprises the following steps: a) preparing a polysaccharide solution containing at least two components, wherein one of the components comprises a polysaccharide which, when precipitated from a solution by evaporation of the solvent, directly forms a film, and wherein the second component comprises a polysaccharide which, when precipitated out from a solution by evaporation of the solvent, forms a film that is partial with respect to gel formation and can interact with the first described polysaccharides. b) applying the solution of step a) on a surface before being subjected to contamination; c) allowing the applied solution to dry in order to form a solid film on said surface by formation of at least a partial gel; d) treating the film coated surface with a liquid able to re-dissolve the film or at least swell by liquid entrapment; and e) removing the undesired contamination by totally or partially removing the film from the surface. The first polysaccharide is selected from cellulose and its derivatives, starch and its derivatives, plant gums, microbial polysaccharides, such as dextran and xanthan or algae polysaccharides, such as agar (see claims 7 to 9 of WO1995025604A).

The main difference between WO1995025604A and the present invention is the technical field, since WO1995025604A discloses a process to protect surfaces from undesired contamination and the present invention is directed to control the amount of powder or particulate material suspended in air or water. Secondly, the microbial polymers used are different, since WO1995025604A uses dextran, xanthan or agar, while the present invention uses negatively charged EPS. Another radical difference relies in the form of application of this invention, since in the present invention the EPS solution is applied into the air, added into water or disposed in a filter through which air with suspended material passes; while WO1995025604A discloses forming a polysaccharide film on the solid surface to be protected from contamination and the removal of contaminants is carried out by subsequent partial or total removal of the film applied to the surface. In another aspect, WO1995025604A discloses a method that requires a high concentration of the polymer mixture to generate a solid film or layer. Contrarily, the compositions of the present invention only require the negatively charged EPS, with no requirement of other polymers to generate the effect of charge attraction that allows precipitating the suspended material, and also the concentration at which they are used is very low, not requiring saturating solutions of negatively charged EPS.

The document WO2001075138A (Eastman Chem. Co., Apr. 2, 2001) describes a method to produce and isolate EPS. This publication discloses a method to produce purified exopolysaccharides from the bacterium Thauera MZ1T, able to produce rhamnose, xylose, galacturonic acid, galactose, glucose, N-acetylfucosamine and N-acetylglucosamine. This bacterium was found and isolated from wastewater treatment plants of a manufacturer of industrial chemicals. The exopolysaccharides of this bacterium are used in a method to remove metals from a complex mixture, by contacting the bacterial EPS with the metal and then removing the EPS-metal complex from the liquid sample. Another method of his publication describes a way of chelating the metal from a sample to which EPS are added. Again, the present invention differs from document WO2001075138A in the technical field, since the publication is directed to remove metals from complex mixtures resulting from industrial processes and fluid flows, wherein said metals are metal ions in aqueous or non-aqueous liquid samples (see page 7, lines 6 to 10 of WO2001075138A); while the present invention is directed to the control or powder or material suspended in air or water. The publication WO2001075138A enumerates many uses for exopolysaccharides, but none of these uses is related with the application of EPS to remove material in suspension.

Accordingly, the present invention solve the technical problem of decreasing the amount of particulate material suspended in air or water, in any situation in which it is desired to decrease the amount of particulate material in suspension, and especially in industrial processes that generate particulate material suspended in air or water, through agglomeration with negatively charged extracellular polymeric substances (EPS). To decrease the amount of particulate material suspended in air, this can be sprayed with a negatively charged EPS solution according to the invention, or the EPS can be immobilized on a filter which the air with particulate material passes through. To decrease the amount of particulate material in water, a suspension with a negatively charged EPS solution according to the invention is added to said water, which agglomerates and settles the particulate material. This solution has not been anticipated or suggested in the previous art.

### BRIEF DESCRIPTION OF THE INVENTION

The invention is directed to a method to decrease the particulate material in suspension, either in air or water, by means of agglomeration with negatively charged Exopolysaccharides (EPS). To decrease the amount of particulate material suspended in air, this can be sprayed with a negatively charged EPS solution according to the invention, or the EPS can be immobilized on a filter which the air with particulate material passes through. To decrease the amount of particulate material in water, a suspension with a negatively charged EPS solution according to the invention is added to said water, which agglomerates and settles the particulate material.

The negatively charged EPS is produced by bacteria or microalgae and can be used isolated or in combination with the microorganisms that produce said EPS.

### BRIEF DESCRIPTION OF THE DRAWINGS

FIG. 1. Settling of the particulate material in liquid medium using 1% purified and resuspended EPS. The figure shows at left the resulting particulate material settling in liquid medium using the purified EPS and at right the settling in water.

FIG. 2. Settling rate of particulate material in liquid medium. The settling rates of particulate material in water (Control), in cultures of the microorganisms that produce the negatively charged EPS, Strain SLIM P22 and Microalga P11C18, and in solutions of EPS isolated from these microorganisms are compared. All the analyzed conditions are much better than the control and no significant differences are observable when using the complete culture with respect to the use of the isolated EPS.

FIG. 3. Adherence assay of the particulate material on different biofilms. The microphotographs show with 10× magnification at left the biofilm before powder application and at right after applying the suspended powder. (A) Control, agar-agar film, (B) biofilm of bacterial strain SLIM 5 FACH, (C) biofilm of bacterial strain SLIM P22, and (D) biofilm of microalga P11C18.

FIG. 4. Assays of the particulate material in EPS biofilms. Weight difference between the biofilms before and after exposure to the particulate material are shown for the Control agar-agar film, the biofilm of the bacterial strain SLIM 5 FACH, the biofilm of the bacterial strain SLIM P22 and the biofilm of the microalga P11C18.

FIG. 5. Particulate material agglomerated by spraying with 1% solutions of negatively charged EPS obtained from bacteria SLIM P22 (B), SLIM 5 FACH (C) and microalga P11C18 (D), using water as a control (A), is shown.

### DETAILED DESCRIPTION OF THE INVENTION

The invention is directed to a method to decrease the particulate material in suspension, either in air or water, by means of agglomeration with negatively charged Exopolysaccharides (EPS). To decrease the amount of particulate material suspended in air, this can be sprayed with a negatively charged EPS solution according to the invention, or the EPS can be immobilized on a filter which the air with particulate material passes through. To decrease the amount of particulate material in water, a suspension with a negatively charged EPS solution according to the invention is added to said water, the mixture is eventually homogenized, and the negatively charged EPS is allowed to agglomerate and settle the particulate material.

The negatively charged EPS used in the present invention is produced either by bacteria or by microalgae. Our assays show that the same results can be obtained using said EPS in isolated form or combined with the microorganisms that produce said EPS.

The negatively charged EPS allow agglomerating the solid material in suspension by means of the charge attraction principle, since the majority of the solid material suspended in air or water has a positive charge.

As mentioned before, any negatively charged EPS can be used in the method of the present invention, but negatively charged EPS from pure bacteria or microalgae cultures are advantageously used to ensure EPS homogeneity. Advantageously, cultures of bacteria or microalgae that produce large amounts of EPS are also used.

To determine if the EPS produced by a microorganism has a negative charge, any available method in the state of the art can be used, such as electrophoresis in agarose gels.

If the negatively charged EPS is used in isolated form, said EPS is collected from the culture medium in which EPS-producing bacteria or microalgae grow, which secrete it into the medium. As an example to recover EPS from the supernatant of a culture medium, a precipitation using alcohol at low temperatures can be carried out, which agglomerates the EPS, and subsequently the EPS can be separated from the medium through centrifugation. However, the negatively charged EPS used in the method of the invention can be obtained by any means available in the state of the art.

The negatively charged EPS can be used in combination with the microorganism that produces said EPS. In this case, the entire culture is subjected to alcohol precipitation or is simply centrifuged to get a microorganism and EPS pellet that can be used with the method of the invention. In case of necessity, the microorganisms can be inactivated, for instance by irradiation with UV light for 30 minutes, before using this microorganism and EPS mixture in the method of the present invention. The culture of negatively charged EPS producing microorganisms can be used as a whole, for example by adding it to a liquid medium to settle particulate material in suspension in said liquid medium.

The method of the present invention is very useful to decrease the amount of suspended particulate material in industrial processes that generate suspended particulate material. Among these industrial processes, mining operations are especially worth mentioning, since they move large amounts of soil and generate amounts of powder suspended in the air and neighboring water sources.

### EXAMPLES

### Example 1

### Production of Negatively Charged EPS

To produce EPS, 6 bacterial strains isolated from a group of slime generating bacteria, which were called: SLIM I, SLIM U, SLIM V, SLIM H, SLIM P 22, SLIM 5 FACH; and 4 microalgae strains from the Nitzscia sp. species, which were called Lc Col1, P3C4, P10C15, P11C18, in normal culture conditions in liquid or solid media. Once saturation conditions of said cultures were attained, the EPS was extracted.

To extract the EPS from the microorganisms, a 40 mL aliquot was taken from each bacteria and microalgae strain culture in their respective media and was centrifuged at 1000 g for 20 minutes. The supernatant was filtered through a 0.2 μm pore-size filter and the filtered solution was reserved. Additionally, the pellet obtained by centrifugation was resuspended in a 1% SDS, 1 mM EDTA, pH 2.5 solution and incubated for 45 minutes at room temperature to release the EPS content from inside the microorganisms. Subsequently, the suspension was centrifuged at 10,000 g for 20 minutes and filtered through a 0.2 μm pore-size filter, to obtain a second filtered solution. The filtrates from the supernatant and the resuspended pellet were joined together and a 0.5 mL aliquot was taken from this solution to precipitate the EPS by addition of 3 mL of absolute ethanol at −20° C. The solution was stirred and centrifuged at 4,500 rpm for 20 minutes to get a pellet corresponding to the isolated EPS. These EPS were dried in an oven at 40° C. overnight. The dried EPS were disaggregated in a mortar and stored in Eppendorf tubes.

To determine the amount of EPS obtained by this method, the pellets were resuspended with 2 mL 1 M NaOH at 60° C. in a water bath, in order to obtain solutions that can be analyzed.

The amount of total carbohydrates in the EPS solution was determined through the Phenol-Sulfuric method, measuring sample absorbance at 492 nm and obtaining the concentration (Table I) using a calibration curve previously made using glucose as standard sugar.

TABLE I
Amount of polysaccharides isolated from each strain

| | Amount of EPS |
|---|---|
| EPS isolated from bacteria | (mg of total sugars/L)*¹ |
| SLIM I | 60.3 |
| SLIM U | 36.6 |
| SLIM V | 53.4 |
| SLIM H | 53.8 |
| SLIM P 22 | 72.2 |
| SLIM 5 FACH | 64.5 |
| EPS isolated from | Amount of EPS |
| microalgae | (mg of total sugars/L)*² |
| Lc Col1 | 32.54 |
| P3C4 | 11.73 |
| P10C15 | 28.74 |
| P11C18 | 76.93 |

*¹The amount of EPS is normalized per 1.66 × 10⁹ bacteria.
*²The amount of EPS is normalized per 3.73 × 10⁶ microalgae cells.

Bacterial strains SLIM P 22 and SLIM 5 FACH and the microalga P11C18 are those that produce the largest amounts of EPS. However, all EPS were also evaluated according to their physicochemical characteristics.

The physicochemical characterization of the EPS was performed through thin layer chromatography. For this, aluminum-supported chromatographic plates were used. The polymer samples were resuspended in chloroform and loaded with a capillary tube. Each sample was eluted with chloroform and with methanol during approximately 30 minutes. EPS with no net charge should migrate better in chloroform, while EPS with a net charge, either positive or negative, should migrate better with methanol. Once the chromatography was carried out, the plate was developed in a transilluminator with ultraviolet light. The results for Migration Distances (MD) of each sample with each of the solvents is shown in Table II.

TABLE II
Migration of the different polymers in chloroform and methanol

| | | MD in Methanol |
|---|---|---|
| | MD in Chloroform (cm) | (cm) |
| Bacteria | | |
| SLIM I | 0.3 | 6.1 |
| SLIM U | 0.2 | 5.8 |
| SLIM V | 0.2 | 8.5 |
| SLIM H | 0.1 | 7.4 |
| SLIM P22 | 0.1 | 7.9 |
| SLIM 5 FACH | 0.3 | 8.2 |
| Microalgae | | |
| Lc Col1 | 7.0 | 0.2 |
| P3C4 | 0.4 | 7.3 |
| P10C15 | 5.5 | 0.1 |
| P11C18 | 0.6 | 6.8 |

All bacteria samples and microalgae samples P3C4 and P11C18 showed a low migration in chloroform and high migration with methanol, which indicates that the isolated EPS present a high polarity. Thus, all of them are good candidates for the generation of compounds that could bind charged particles in suspension.

After the chromatographic analysis that showed that EPS from all bacterial samples and microalgae samples P3C4 and P11C18 are charged, the EPS electrical migration behavior was assessed to determine if this charge is positive or negative. For this, an electrophoresis in agarose gels was performed. Separation was carried out through a porous matrix; a 1% agarose gel in PBS buffer was used in this assay.

Once the samples were loaded into the gel, an 80 volt electric potential was applied for 30 minutes. To visualize the EPS, a concentrated alcian blue dye solution was used. Once the dye is solubilized, it is added to the agarose gel to determine the charge according to the electrical migration. As a result of this analysis, it was concluded that all the assayed EPS are negatively charged.

Since strains SLIM P22, SLIM 5 FACH and P11C18 are the highest producers and they show the desired negative charge characteristics, the following work was performed only using these strains.

### Example 2

### Decrease of the Amount of Particulate Material Suspended in Water with Cultures that Produce Negatively Charged EPS

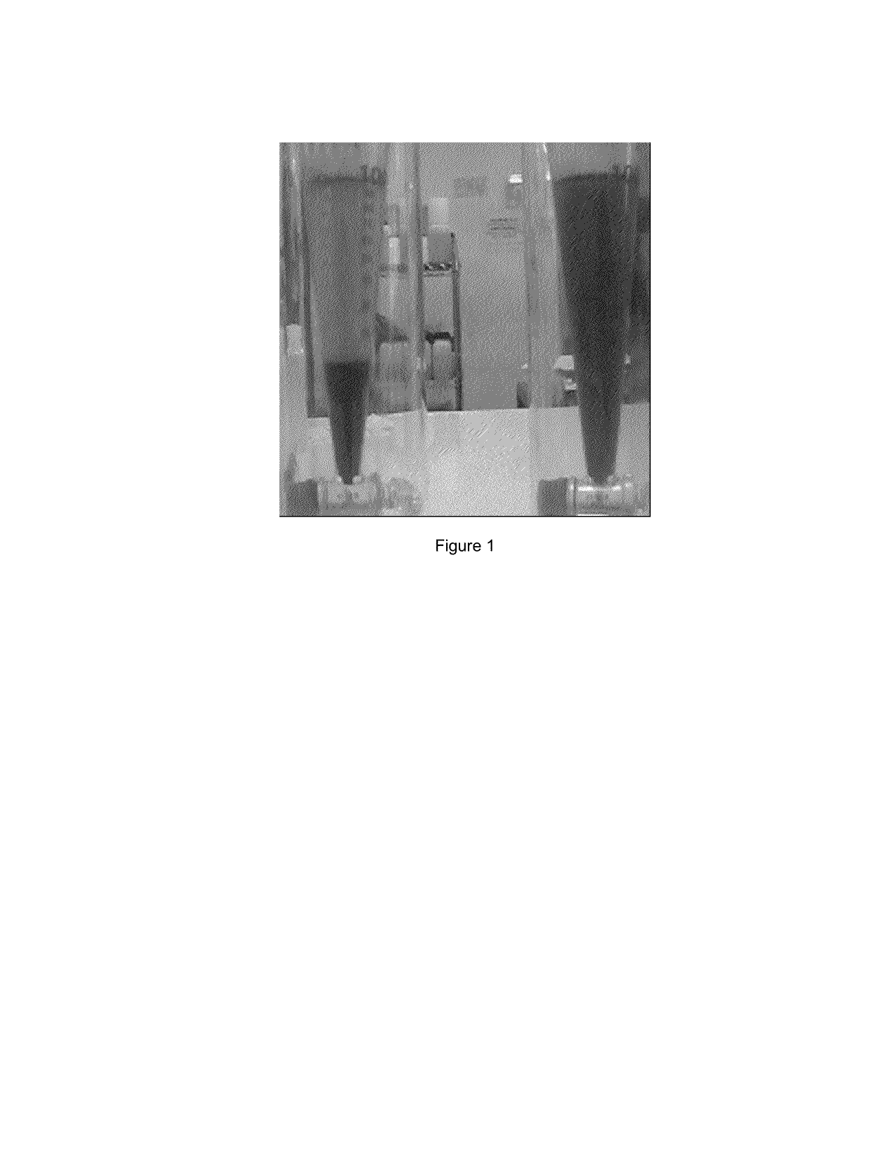

10 g of particulate material to be settled were weighed. The material, which consists of a suspended fine powder obtained from mining activities, was added to a graduated IMHOFF cone. An IMHOFF cone is a graduated styrene-acetonitrile (SAN) cone. This material was selected given that the suspended particles do not adhere to it. The material was homogenized in 100 ml of the culture medium in stationary phase (corresponding to the culture medium+microorganisms+EPS in solution) of the negatively charged EPS-producing microorganisms corresponding to bacteria SLIM P22 and SLIM 5 FACH and the microalga P11C18. The isolated EPS from the strain SLIM P22 and the microalga P11C18 were also assayed, adding 1 g of isolated EPS in 100 ml of culture medium without microorganisms. Another IMHOFF cone with particulate material and 100 ml of distillate water was used as a control. After homogenizing the material, the decanted volume in the cone was measured at each time interval to calculate the settling rate and the percentage of settled material and remaining suspended material (FIG. 1).

Subsequently, the settling rate of the material able to be settled was calculated for each of the samples. For this, different time intervals were selected during the settling assay in the IMHOFF cone, and the settled volume is plotted (as a displacement factor) versus the time in minutes (as unit of time) during which the phenomenon takes place. In each case, the slope is calculated to measure the mean settling rate. This value allows comparison between the settling rates of the samples treated with the polymers with respect to the water control (Table III).

TABLE III
Settling rate in liquid medium.

| Liquid medium used | Settling rate (ml/min) |
|---|---|
| Control (water) | 19 |
| Bacterial strain SLIM 5 FACH culture | 73 |
| Bacterial strain SLIM 22 culture | 81 |
| Microalga P11C18 culture | 142 |
| EPS from bacterial strain SLIM 22 | 83 |
| EPS from microalga P11C18 | 153 |

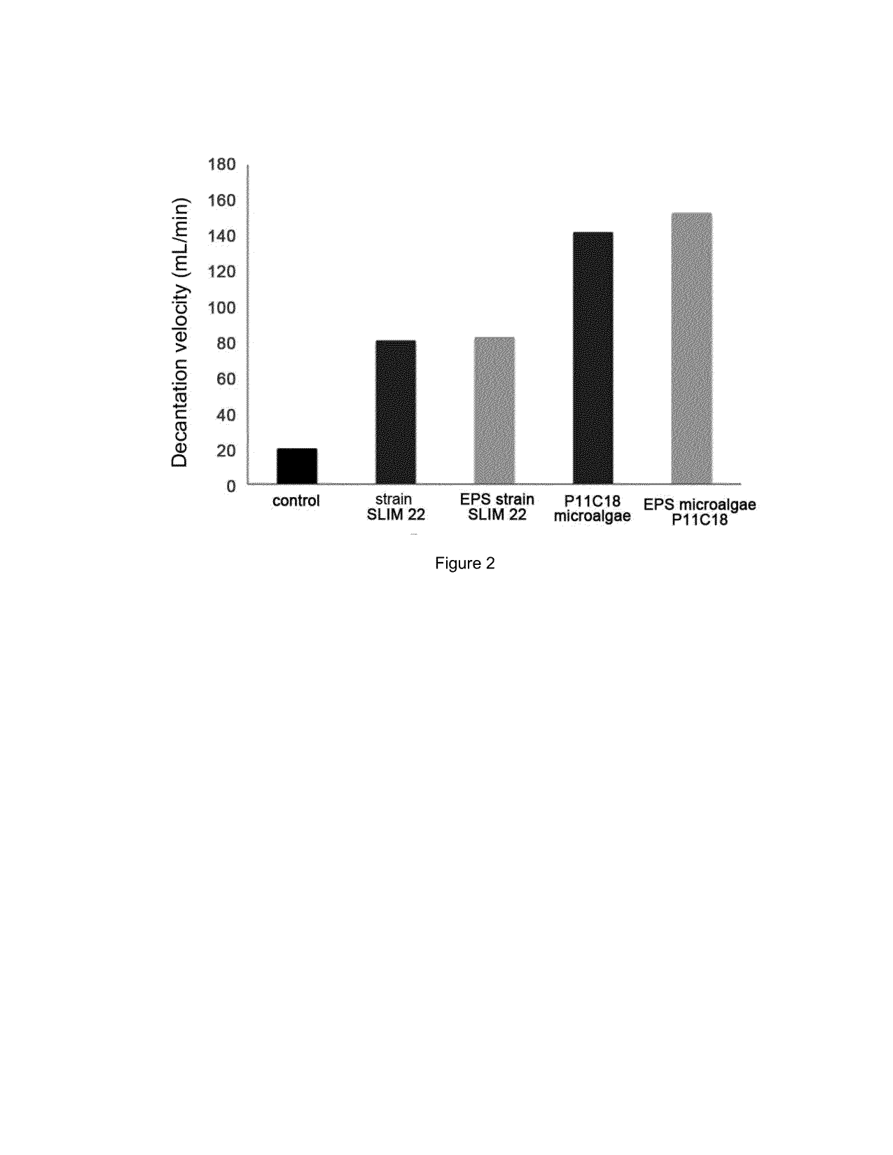

As shown in Table III, the cultures of negatively charged EPS producing-microorganism cultures, as well as the negatively charged isolated EPS, considerably increased the settling rate of particulate material in the liquid medium with respect to the control, which indicates that indeed an interaction took place between them. FIG. 2 shows the settling rate of the control, the cultures of the strain SLIM 22 and the microalga P11C18, indicated as “Strain SLIM P22” and “Microalga P11C18”, and the EPS isolated from the same microorganisms, with data from Table III. FIG. 2 clearly shows that no significant differences exist when using the whole culture and using the isolated EPS. Therefore, according to the present invention, both can be indistinctly used.

For the same experiments, the total percentage of settled material after 24 hours from the start of settling was calculated. Results are shown in Table IV.

TABLE IV
Percentage of settled and suspended material from the
particulate material after 24 hours of settling.

| | Percentage of settled | Percentage of |
|---|---|---|
| Liquid medium used | material | suspended material |
| Control (water) | 61% | 39% |
| Bacterial strain SLIM 5 | 78% | 22% |
| FACH culture | | |
| Bacterial strain SLIM 22 | 79% | 21% |
| culture | | |
| Microalga P11C18 culture | 68% | 32% |

The results show that the presence of the negatively charged EPS producing-microorganism cultures increases the percentage of settled material in comparison with the control, which is in accordance with the values obtained for the settling rate. It is important to note that both parameters are independent (rate and % of settled material), hence the presence of the negatively charged EPS producing-microorganism cultures improves both parameters.

### Example 3

### Decrease of the Amount of Particulate Material Suspended in Air with Negatively Charged EPS

To carry out the settling assays of particulate material in air, 10 g of particulate material were weighed and deposited into a graduated IMHOFF cone. 2 ml of EPS solution were added to the 10 g of material, the mixture was stirred to homogeneity, the cone is subsequently put facing down to achieve the material precipitation and it is left to decant for half an hour with the valve open to allow the entrance of air into the system. Subsequently, the amount of settled material was weighed. The 2 ml of solution used for this assay had a concentration of 0.5%, 1% and 5% of EPS in a weight/volume ratio, and independent assays were carried out for each condition. Another IMHOFF cone with 10 g of particulate material and 2 ml of distillate water was used as a control. The results are shown in Table V.

TABLE V
Settling of particulate material with different polymer concentration.

| | Amount of | | |
|---|---|---|---|
| | settled material (g) | | |
| Concentration of EPS (w/v) | 0.5% | 1% | 5% |
| Control (water) | 10.9 | 11 | 10.7 |
| EPS isolated from bacterial strain SLIM 5 | 11 | 12.5 | 11.5 |
| EPS isolated from bacterial strain SLIM 22 | 11 | 14 | 13 |
| EPS isolated from microalga P11C18 | 11 | 12.3 | 11.9 |

The results show no significant differences with respect to the control when samples are sprayed with a concentration of 0.5% of negatively charged EPS. Hence, this concentration is insufficient to achieve en effective charge in the particulate material. The highest settling rate is obtained with the EPS applied at 1%, since when increasing the concentration of the polymer up to 5% the effect to attract particulate material decrease, probably by medium saturation. These assays determine an optimal concentration to apply the negatively charged EPS to decrease the amount of suspended particulate material in air is a 1% w/v solution.

### Example 4

### Assays with Biofilms

For this assay, biofilms were made using negatively charged EPS producing microorganisms of the bacterial strains SLIM P22 and SLIM 5 FACH and the microalga P11C18. To this aim, an aliquot of the culture of each of these microorganisms was independently placed on a slide, which was incubated at room temperature during two weeks. At the end of this period, on each slide a thin layer or biofilm of each microorganism was generated.

A slide with a thin agar-agar layer was used as a control. To obtain this agar-agar layer, the sides of the slide were covered with paper sticky tape to generate a 2 cm-high container to which 2 mL of melt 1% agar-agar were added. When this solution cooled down, it formed a thin layer (approximately 1 mm-thick) of solidified agar-agar gel on the slide, similar to the biofilms formed by the negatively charged EPS-producing microorganisms.

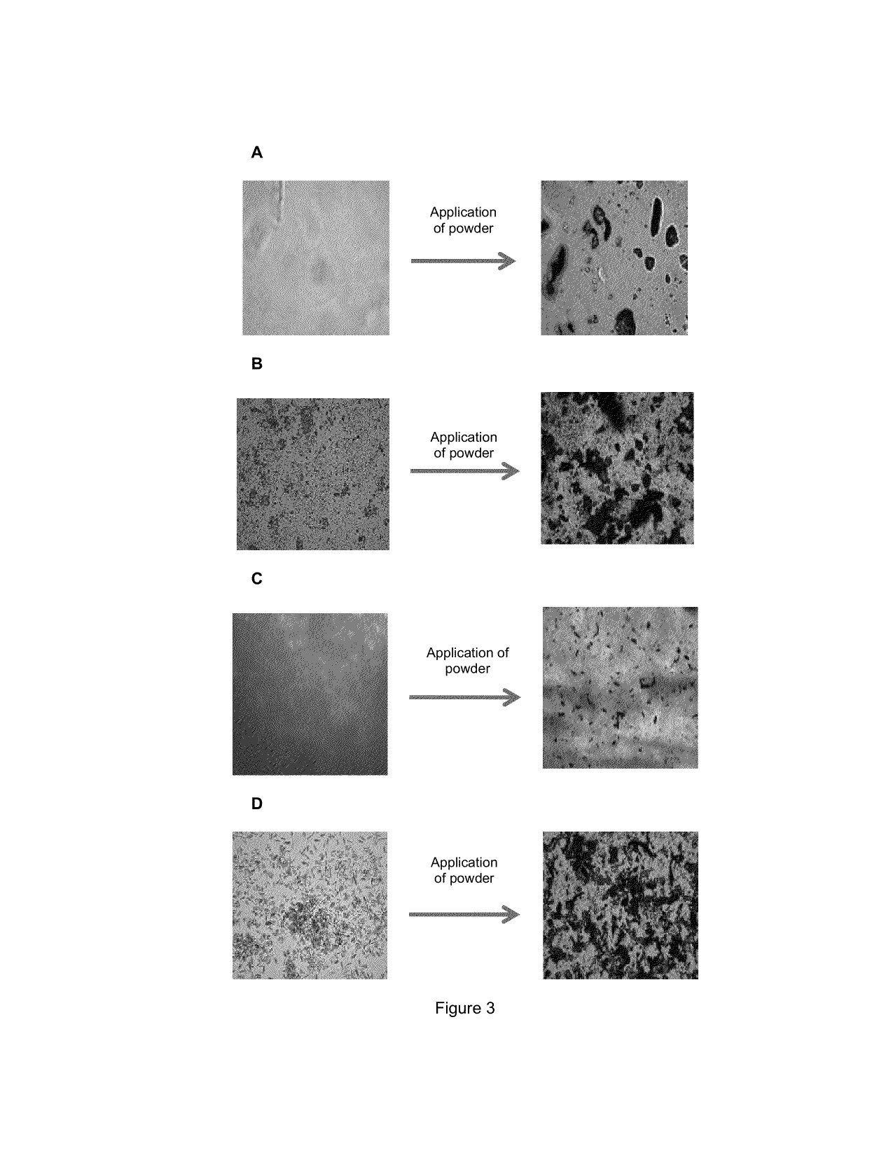

Once obtained the biofilms, they were weighed and observed under the microscope with a 10× magnification, to get a reference of the state of the biofilms before being exposed to suspended powder, which was recorded in photographic pictures. See FIG. 3, wherein (A) corresponds to the control, agar-agar film, (B) is the biofilm of the bacterial strain SLIM 5 FACH, (C) is the biofilm of the bacterial strain SLIM P22, and (D) corresponds to the biofilm of microalga P11C18.

To assess the capacity of the generated biofilms to retain particulate material, a test reactor was built, consisting of a graduated acrylic conical tube with 58 cm in length and 10 cm in diameter, having a detachable top lid for the entrance of powder, wherein each of the EPS biofilms are independently placed inside the upper part of the conical tube with the help of a plastic support. In the lower part of the cone, there is a polyester filter to avoid the powder to fall down, given the size of its pores, but allowing a continuous air flow to enter.

Then, each biofilm was placed inside the reactor through the upper part of the test reactor and the reactor was switched on with a load of 10 g of mine powder, maintaining the flow during 1 minute. After this period, the biofilm was removed, weighed and observed again under the microscope to assess the changes with respect to the initial record (FIG. 2).

The results show that the amount of particulate material retained by the biofilms of the invention, tests (B), (C) and (D), was higher than the agar-agar control; in fact, it was between 3.5 and 4.2 times higher than the control, since the biofilms of the invention have a higher capacity to attract and keep retained powder particles due to the presence of negatively charged EPS.

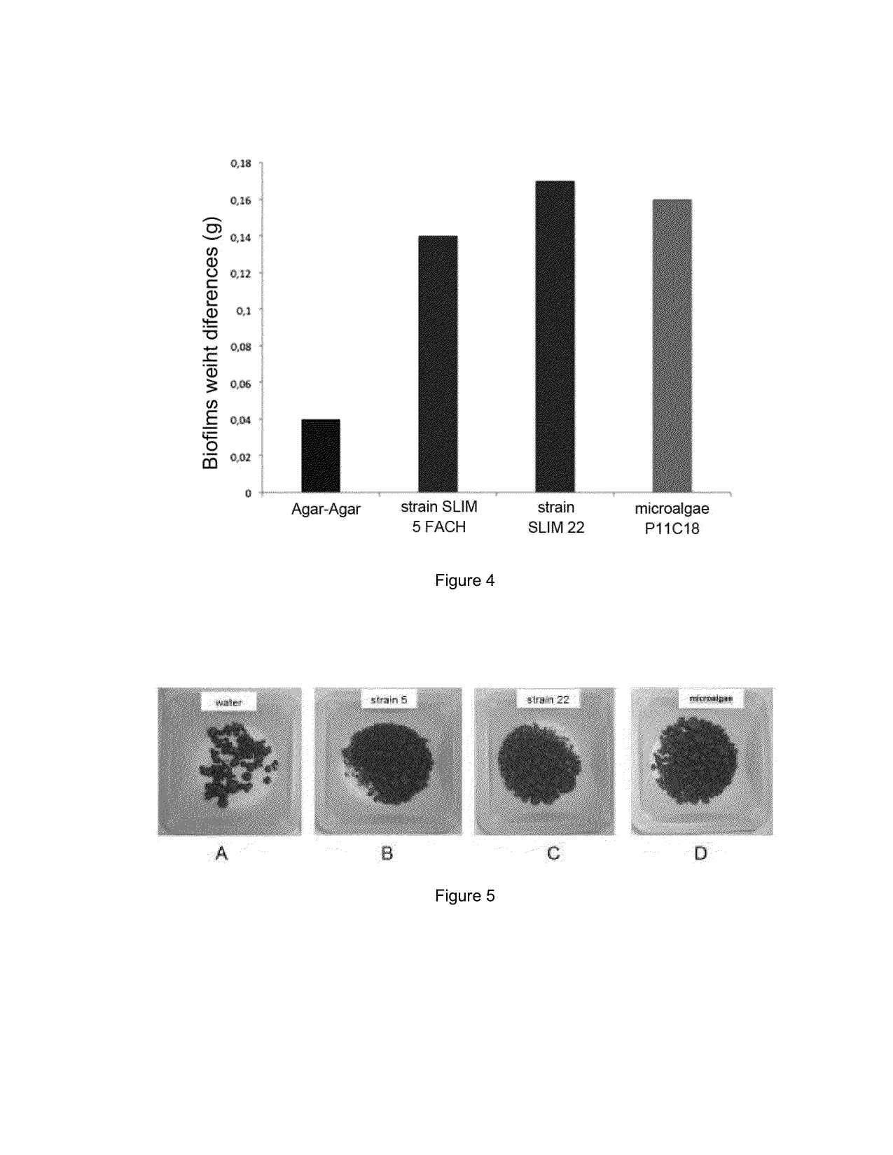

The weight difference or delta (g) of the different biofilms and the control before and after the exposure to particulate material in the assay reactor equals the material that is effectively attracted and retained by the biofilm. These results are shown in Table VI and plotted in FIG. 4.

TABLE VI
Weight of the biofilms before and after exposure to particulate material

| | Weight of the biofilms (g) | | |
|---|---|---|---|
| | Before the | After the | |
| | exposure | exposure | Weight delta (g) |
| Agar-agar control | 6.65 | 6.69 | 0.04 |
| Biofilm of Strain SLIM 5 | 4.83 | 4.97 | 0.14 |
| FACH | | | |
| Biofilm of bacterial Strain | 4.94 | 5.11 | 0.17 |
| SLIM P22 | | | |
| Biofilm of Microalga P11C18 | 4.81 | 4.97 | 0.16 |

### Example 5

### Agglomeration Dynamics

Assays were carried out to determine the physical properties of the settled material using the negatively charged EPS of the invention. For this, 2 ml of a 1% solution of negatively charged EPS were added to 10 g of particulate material. This solution was homogenized and the physical characteristics of the agglomerate were registered. Results are shown in FIG. 5.

An increase in the amount of settled particulate material is observed when the particulate material is sprayed with the 1% negatively charged EPS solution in comparison with the water control. Besides obtaining a higher amount of agglomerated material, this is finer and more compact than the agglomerate with water.

1. A method to decrease the amount of particulate material suspended in air or water wherein said method comprises agglomerating the particulate material suspended in air or water with negatively charged exopolysaccharides (EPS).

2. A method according to claim 1, wherein the negatively charged EPS is applied isolated or in combination with a microorganism that produces said negatively charged EPS.

3. A method according to claim 2, wherein the microorganism that produces the negatively charged EPS is at least one of: a bacterium or a microalga.

4. A method according to claim 1, wherein the negatively charged EPS is sprayed on the air with suspended particulate material and allows said suspended particulate material to settle.

5. A method according to claim 4, wherein the negatively charged EPS is sprayed on the air in a solution with a concentration between 0.5 and 5%.

6. A method according to claim 5, wherein the negatively charged EPS is sprayed on the air in a solution with a concentration of 1%.

7. A method according to claim 1, wherein the negatively charged EPS is added to water with suspended particulate material, the mixture is eventually homogenized, and it is allowed to settle.

8. A method according to claim 7, wherein the negatively charged EPS is added to the water in a solution with a concentration between 0.5 and 5%.

9. A method according to claim 7, wherein the negatively charged EPS is added to the water in a solution with a concentration of 1%.

10. A method according to claim 1, wherein the negatively charged EPS is arranged as a film over a solid surface that contacts the air with suspended particulate material.
